(19) United States
(12) Patent Application Publication
(10) Pub. No.: US 2007/0193375 A1
(43) Pub. Date: Aug. 23, 2007

(54) System and method for sampling liquids

(76) Inventors: Michael Pandori, Vernon, NJ (US); Jason Nisler, Newton, NJ (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 11/488,573

(22) Filed: Jul. 18, 2006

Related U.S. Application Data
(60) Provisional application No. 60/774,968, filed on Feb. 17, 2006.

(51) Int. Cl. G01N 1/16

(52) U.S. Cl. 73/863.31

(57) ABSTRACT

Embodiments of the invention are directed to a system for sampling sterile liquids in a pharmaceutical environment. The system can include a nesting station, the nesting station including one or more divert valves, a manifold, disposed partially within the nesting station, the manifold comprising one or more tubes, an input valve, coupled to the manifold, the valve being designed and dimensioned to control the flow of liquid into the manifold, and one or more sampling pouches, each sampling pouch coupled to one of the tubes. Each of the divert valves can be used to selectively control the flow of liquid from the manifold, into the sampling pouches.

### CROSS-REFERENCE TO RELATED APPLICATION

This application claims the benefit of U.S. Provisional Patent Application No. 60/774,968, filed on Feb. 17, 2006, the contents of which are hereby incorporated by reference herein.

### FIELD OF THE INVENTION

The invention relates generally to liquid sampling systems, and, more particularly, to systems and methods for facilitating liquid sampling.

### BACKGROUND OF THE INVENTION

In the biotech, pharmaceutical, chemical, and other fields that use tubing in the processing and transport of fluids, there is often a need for sampling and testing of liquid product samples. These samples are typically isolated from the environment, which would otherwise contaminate the high purity liquid in the sample.

Some existing sampling methods use components that implement a diaphragm seal, creating a dead leg for liquid entrapment, and possible breaches in sterility. Dead areas can also be introduced by the use of commonly implemented pinch valve designs. Other known methods make use of multiple gaskets and a separate sealing apparatus to make a seal. The use of these additional components adds to the cost of sampling, and introduces the potential for failure from pressures or contamination.

Welded plastic or metal assemblies are also presently used. These assemblies are relatively costly and require extensive labor for the cleaning process. Separate valves are required to manipulate flow in these metal or plastic designs. Other designs utilize plastic, mechanical barb junctions with tubing sections. These seals add components, thus increasing costs and the potential for failure from pressures or contamination.

With some existing methods of sampling, the sampled liquid is exposed to components made of multiple materials, which can lead to a traceablity problem. That is, with the use of multiple materials, any contamination of, or reaction with, a liquid, can be difficult to isolate and identify.

Other designs implement simple pinch clamps on the outside diameter of flexible tubing. These clamps are an added cost to a sampling system, and are not a secure, validated method of closure for pharmaceutical and biotech applications.

Thus, there is a need for an improved system and method for sampling liquids.

### SUMMARY OF THE INVENTION

Embodiments of the invention satisfy this and other needs by providing an improved system and method for sampling liquids.

Embodiments of the invention are directed to a system for sampling sterile liquids in a pharmaceutical, or similar, environment. The system can include a nesting station, the nesting station including one or more divert valves. A manifold can be disposed partially within the nesting station, the manifold comprising one or more tubes. An input valve can be coupled to the manifold. The valve can be designed and dimensioned to control the flow of liquid into the manifold. One or more sampling pouches can also be included, each sampling pouch coupled to one of the tubes. Each of the divert valves can be used to selectively control the flow of liquid from the manifold, into the sampling pouches.

Embodiments of the invention include a flexible, multi-tube, or lumen, manifold, partially contained within a manifold nesting station. The nesting station can contain divert valves for controlling the flow of liquid though the tubes of the manifold. Embodiments can also include an input valve, for controlling the flow of liquid into the manifold.

Embodiments of the invention incorporate molding technologies to minimize crevices and mechanical connections between parts and components. The liquid will contact one material type from the point of entry into the sampling assembly until it ends in the final container. Embodiments also allow for many, high volume, samples from a single sampling port.

In some embodiments, the manifold is designed as a multi-directional flow station which introduces little or no disturbance of the process liquid. The manifold can be molded as a single piece from silicone to minimize distances between tubes. The molded assembly can create a molecular bond and eliminates crevices and potential for disconnections typical with mechanically connected assemblies.

The manifold nesting station with divert valves can control high purity fluid flow while minimizing the possibility of contaminating the process liquid. The nesting station can be used to selectively compress the internal tubes of the manifold, which contains the liquid, via a cam-actuated bar. By compressing the tubing on the external surface, the internal surfaces of the tubing meet and stop liquid flow, without contaminating the liquid.

Thus, embodiments of the invention provide for a liquid sampling system and method that facilitates efficient and advantageous sampling of liquids.

### BRIEF DESCRIPTION OF THE DRAWINGS

The invention will be more readily understood from the detailed description of exemplary embodiments presented below, considered in conjunction with the attached drawings, of which:

FIG. 1 is a top, front, side perspective view of a liquid sampling system, with the top portion of the manifold nesting block removed, in accordance with embodiments of the invention;

FIGS. 2 and 3 are top, front, side perspective views of a liquid sampling system, with the top portion of the manifold nesting block in place, in accordance with embodiments of the invention;

FIG. 4 is a front view of a manifold nesting station, in accordance with embodiments of the invention;

FIG. 5 is a side cross-sectional view of manifold nesting station, showing a cam valve closing a manifold tube, in accordance with embodiments of the invention;

FIG. 6 is an exploded side cross-sectional view of a steam valve, in accordance with embodiments of the invention;

FIG. 7 is another view of the steam valve of FIG. 6, in accordance with embodiments of the invention;

FIG. 8 is a top view of a sampling pouch, in accordance with embodiments of the invention; and

FIG. 9 is a top view of a sampling pouch, in accordance with embodiments of the invention.

It is to be understood that the attached drawings are for purposes of illustrating the concepts of the invention and may not be to scale.

### DETAILED DESCRIPTION OF THE INVENTION

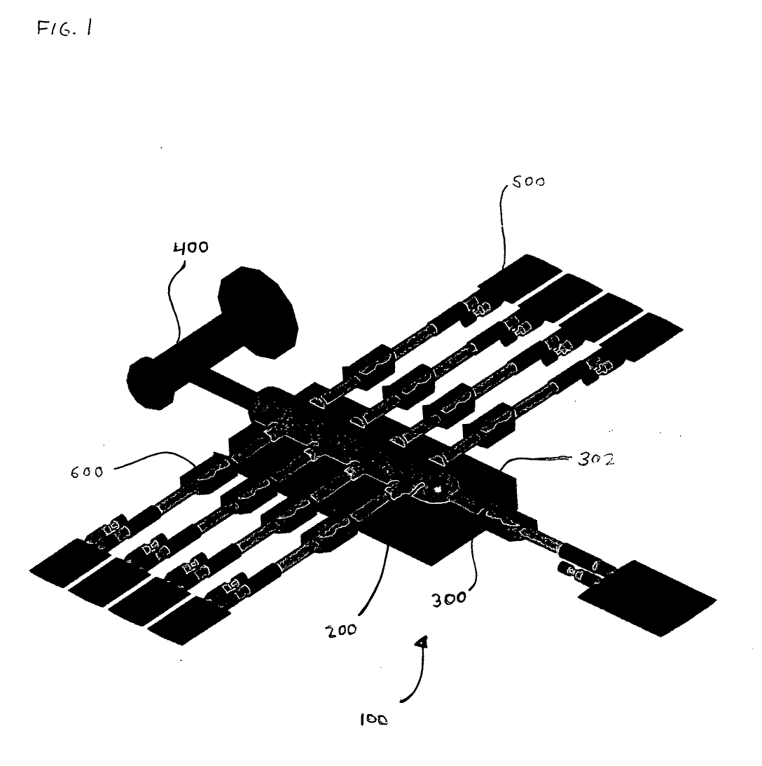

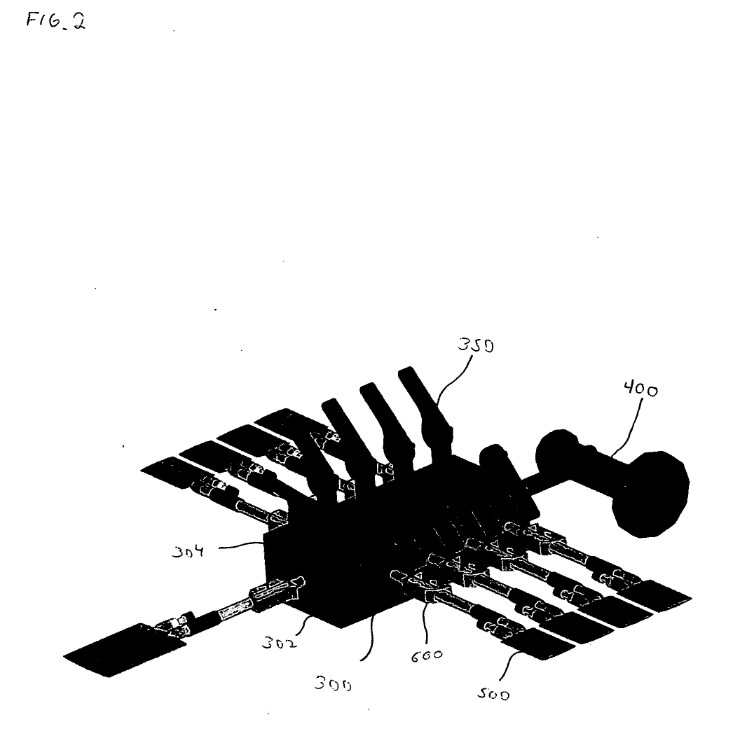

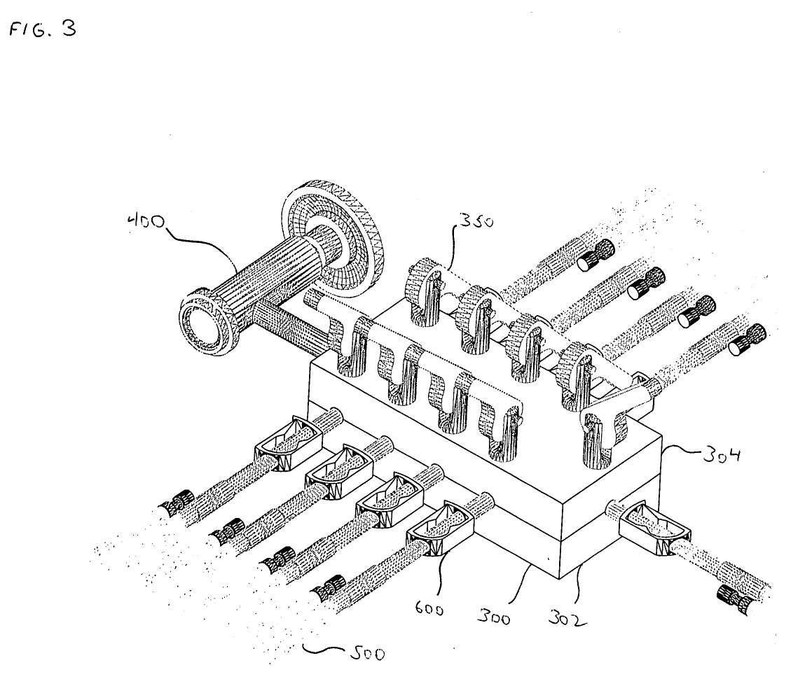

With reference to FIGS. 1-3, there is shown a liquid sampling system 100, in accordance with embodiments of the invention. Embodiments of the system 100 can include a manifold 200, partially contained within a manifold nesting station 300. The flow of liquid into the manifold 200 can be controlled by use of input valve assembly 400. Divert valves 350, positioned at, and being a part of, nesting station 300, can be used to selectively control the flow of liquid out of the manifold 200, through tubes 204. Thus, liquid samples can be selectively collected in sampling pouches 500. Optionally, clamps 600 can be used to control the flow of liquid through tubes 204.

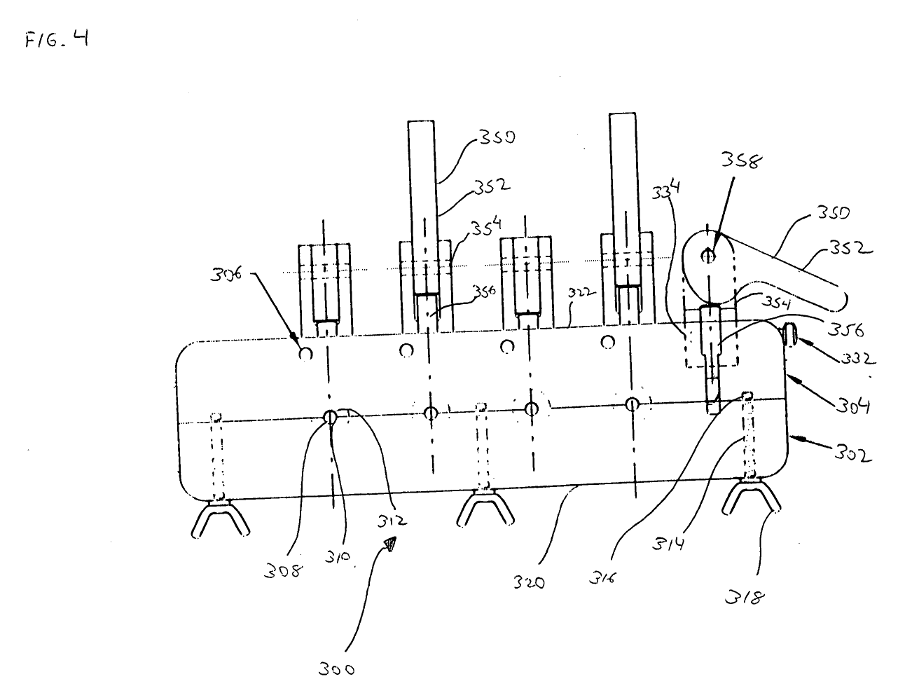

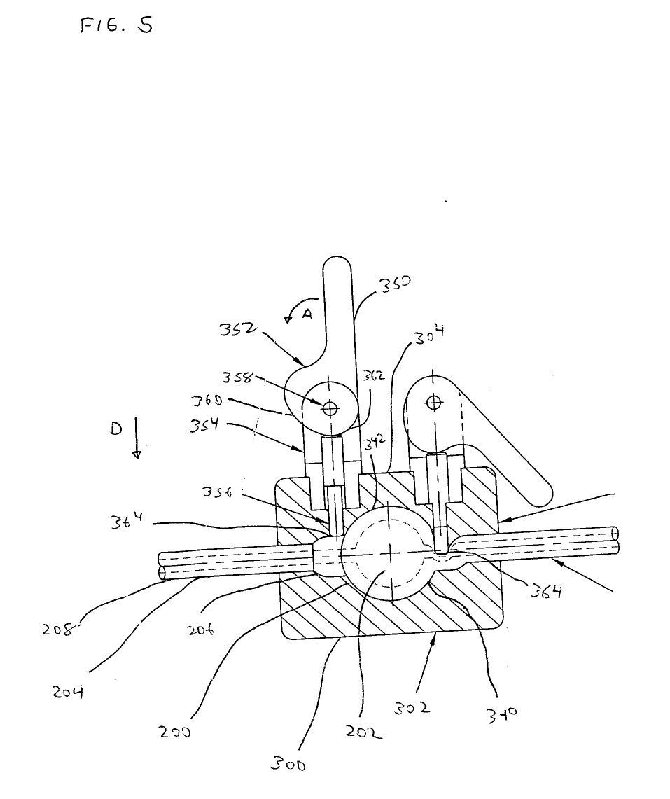

With reference to FIGS. 4 and 5, and continued reference to FIGS. 1-3, manifold nesting station 300 can comprise a bottom portion 302 and a top portion 304. Bottom portion 302 and top portion 304 can include bottom and top bores 314, 316, respectively, designed and dimensioned to facilitate the securing together of bottom portion 302 and top portion 304 by way of a screw connector 318 at bottom surface 320. Alternatively, other designs for the manifold nesting station 300 can be used, as would be known to one of skill in the art, as informed by the present disclosure.

Top portion 304 can include, at top surface 322, recesses 334 defined therein. Each of the recesses 334 can be designed and dimensioned to accept a respective divert valve 350. Top portion 304 can also include holes defined therein, each designed and dimensioned to receive a pin 306 for securing the divert valves 350.

In some embodiments, divert valves 350 can include a lever 352, connected to support 354. As the lever 352 is rotated in direction A about pivot pin 358, cam surface 360 of lever 352 contacts the top surface 362 of plunger 356, causing plunger 356 to move in direction D, and, in turn, causing a bottom surface 364 of plunger 356 to contact an outer surface of tube 204 of manifold 200. As tube 204 is compressed, the flow of liquid from the body 202 of manifold 200 through tube 204, is stopped. Moving lever 352 in the opposite direction allows plunger 356 to be moved in the opposite direction to direction D, thus allowing tube 204 to uncompress, and, in turn, allow for the flow of liquid out of the body 202 of manifold 200, and through tube 204. Valve stem 423 creates a flush face when connecting to another fitting, eliminating or minimizing any areas for entrapment or stagnant liquid which is typical for other soft tubing valves implementing a pinch design. In addition, this design of flush stem face 423 creates a secure seal between the valve enabling the user to apply steam pressure for cleaning during operation. This seal also acts as a sterilizing barrier for all components connected to the valve assembly. Alternatively, other designs and implementations for the divert valves 350 can be used, as would be known to one of skill in the art, as informed by the present disclosure.

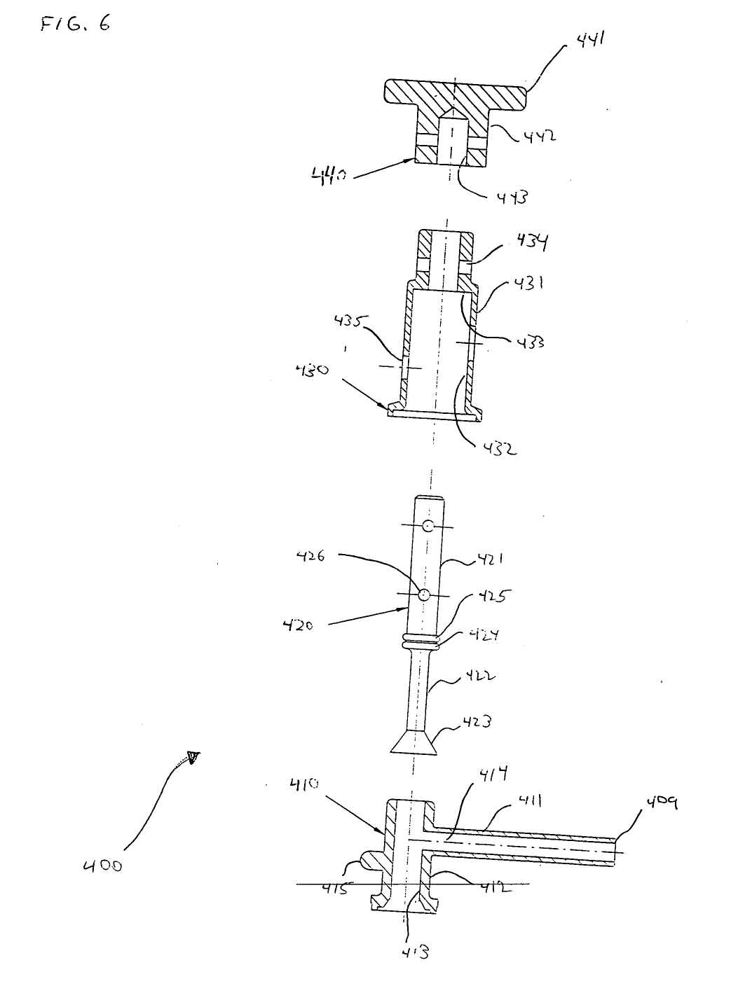

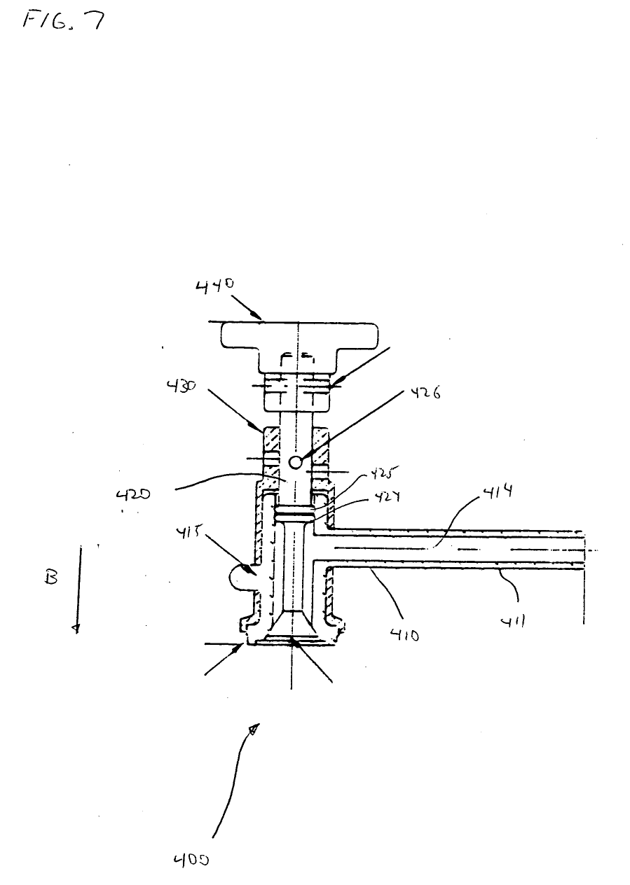

With reference to FIGS. 6 and 7, and with continued reference to FIGS. 1-3, an input valve 400, in accordance with embodiments of the invention, is shown. In some embodiments, input valve 400 can include a valve stem 420 contained within a valve body top portion 430 and valve body bottom portion 410. A valve knob 440 can be positioned on top of valve body top portion 430 and secured to stem top 421 of stem 420. Stem 420 can include a pin 426 disposed thereon, and positioned such that pin 426 fits within spiral slot 434 of valve body top portion 430. In use, when knob 440 is twisted, pin 426 moves within spiral slot 434 to move stem 420 in direction B. When stem 420 moves in direction B, stem head 423 becomes extended beyond the bottom of valve body bottom portion 410, allowing liquid to flow from flow path 414 of tube 411 and out aperture 413. Alternatively, other designs and implementations with stem 420 being positioned in different manners and orientations can be used, as would be known to one of skill in the art, as informed by the present disclosure.

Annular ridges 424, 425 can be disposed at stem 420. Annular ridges 424, 425 can act as a positive stop as the input valve 400 is closed by contacting aperture top surface 433 of valve body top portion 430 when the knob 440 is turned to close the input valve 400. As the input valve 400 is opened, annular ridges 424, 425 can facilitate beneficial alignment of stem 420 as it is moved.

Annular ridges 424, 425 can also provide a double sanitary seal. The two ridges act as integral, moving cavity seals as they press against inner wall of soft elastomer valve body bottom portion 410, creating a sanitary seal from the outside environment. The sealing annular ridges are integral part of the stem 420 which eliminates the need for additional separate components such as, for example, separate mechanically secured O-rings, gaskets, or a seal.

In some embodiments, valve body bottom portion 410 can have alignment nub 415 disposed thereon. Alignment nub 415 can be designed and dimensioned such that it is positioned through alignment aperture 435 of valve body top portion 430. The beneficial cooperative relationship between alignment nub 415 and alignment aperture 435 serves to facilitate positioning of valve body upper portion 430 and valve body lower portion 410 during assembly, and serves to facilitate the maintaining of proper positioning once assembled. Alternatively, other designs for the input valve 400 can be used, as would be known to one of skill in the art, as informed by the present disclosure.

In some embodiments, valve body bottom portion 410 is made from an elastomer, and all primary fluid contact surfaces are made from a high purity rubber or elastomer. This design and configuration of input valve 400 creates a flow control apparatus for a low pressure flexible tube assembly which maintains liquid contact continuity without the need for a separate device, thus eliminating the need for any separate gaskets, seals, or diaphragms, as are typical in presently used systems.

Outlet 409 of valve tube 411 and valve body bottom portion 410 can be made from a single material of construction. This enables a user to mold, weld, or connect a compatible outlet tube directly to the tube 411, thus eliminating any seams or crevices.

Valve body upper portion 430 serves as mechanical reinforcement to the elastomer valve body bottom portion 410 without coming in contact with process liquid. This eliminates the need for a metallic or hard plastic body.

Valve body bottom portion 410, made from elastomer, has an integral gasket seal on the equipment attachment area, which eliminates the need for separate gaskets or o-rings required on metal or plastic flow control devices.

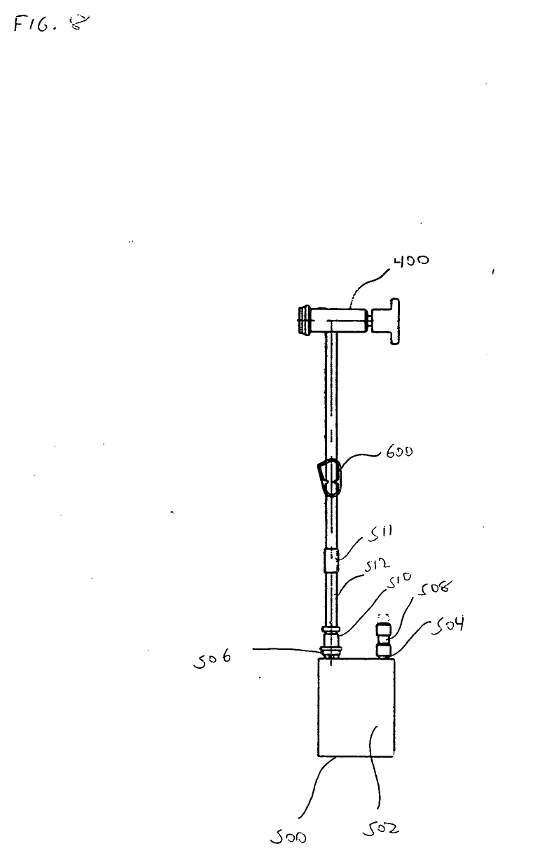

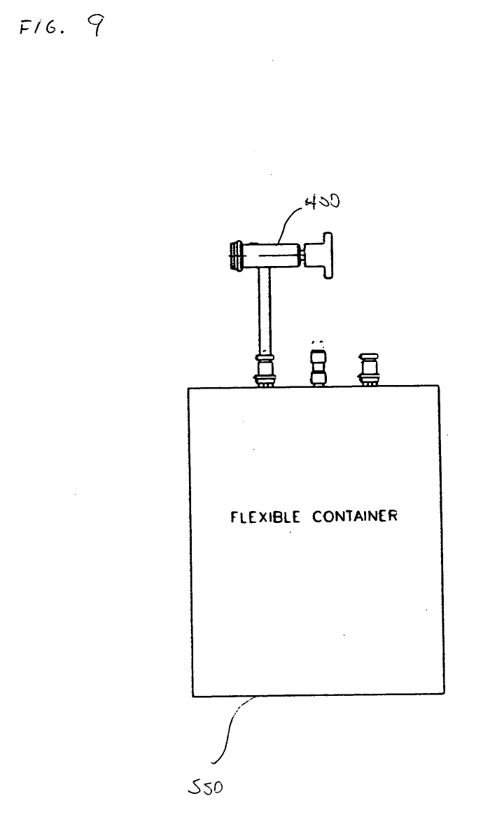

With reference to FIGS. 8 and 9, and continued reference to FIGS. 1-3, there are shown sampling pouches 500, 550, in accordance with embodiments of the invention. In some embodiments, sampling pouches 500, 550 can be used to collect liquid samples. Sampling pouches 500, 550 can be connected to tubes 204 of manifold 200, as shown in FIGS. 1-3. Alternatively, with reference to FIGS. 8 and 9, a sampling pouch 500, 550 can be connected to an input valve 400, with the input valve 400 being used to control the flow of liquid into pouch 550. Coupling pieces can be used to join tube 204 or tube 512 sections to pouch apertures 504, 506, or to selectively seal off one or more of the pouch apertures 504, 506. Alternatively, other designs and implementations for the sampling pouches 500, 550 can be used, as would be known to one of skill in the art, as informed by the present disclosure. In addition, other types of containers can be used to collect samples, such as standard collection bottles, vials, etc, as would be known to one of skill in the art.

Embodiments of the system 100 can make use of molding technologies to minimize crevices and mechanical connections between parts and components. Beneficially, embodiments of the system 100 allow for many, high volume samples from a single sampling port, or input valve 400.

In some embodiments, manifold 200 is formed from molded silicone, in a crevice-free or substantially crevice-free design. In some embodiments, the manifold nesting station and divert valves beneficially do not come in contact with the liquid. The crevice free, molded silicone manifold 200 is designed as a multi-directional flow station, with minimal disturbance of the process liquid. In some embodiments, the manifold 200 is molded in a single piece to minimize distances between tubes, the distances being relatively large in mechanically connected assemblies. In some embodiments, the molded design creates a full molecular bond between sub-components and minimizes or eliminates crevices and potential for disconnections typical with mechanically connected assemblies. Also, embodiments of the invention improve upon existing sampling methods, which, due to manufacturing limitations, are relatively costly and difficult for users to manipulate.

Thus, in some embodiments, manifold 200 can be formed of a multi-tube 204, single-piece molded assembly. In some embodiments, the manifold 200 can be molded in single step/shot. Embodiments of the manifold thus have a close-coupled, compact design, are formed of a single material, are manufactured without the use of adhesives, and are formed with minimal or no crevices or flow transitions.

In some embodiments the input valve 400 is designed as a steam sterilizable flow control valve while minimizing or eliminating the transition of product surfaces and crevices between components. In some embodiments, the input valve 400 allows the user to make a connection to a high-pressure system with low-pressure components. The input valve 400 acts as a sterilization barrier that can withstand steam temperatures and pressures. Thus, the manifold 200 and pouches 500, 550 can be packaged in sterilized packaging, and the input valve 400 can withstand high-pressure sterilizing steam, so that the sampling system can easily be configured as a sterile system. Thus, the valve forms a high-pressure steam barrier for relatively low-pressure tubing (which generally cannot withstand the high pressure steaming process). In some embodiments, portions of the input valve 400 are formed from a biocompatible material, such as a pharmaceutical grade elastomer, such as silicone. In some embodiments, the molded connections between valve parts avoid the need for barbs, or mechanical fittings, as well as separate elastomer seals or separate o-rings. The flush face design of the stem head 423 minimizes dead areas typically found in pinch valve designs. Such dead areas, which collect stagnant liquid, can lead to impurities being introduced into the samples. Also, because the components of the input valve 400 are beneficially mechanically secured, the input valve 400 can withstand high (steam) pressure without the requirement of adhesives. Adhesives can also serve to contaminate liquid samples.

In some embodiments, the nesting station 300 and divert valves 350 are designed as a means to control high purity fluid flow while minimizing the possibility of contaminating the process liquid. As described above, the divert valve 350 can be used to compress a tube 204 of a manifold 200, or compress another tube, which contains the liquid, via a cam-actuated method. By compressing the tube 204 or other tubing on the external surface, the internal surfaces of the tube 204 or tubing meets and stops liquid flow. The nesting station 300 is designed and dimensioned to work in conjunction with the crevice-free, molded silicone manifold 300. Alternatively, the nesting station 300 and divert valves 350 can be configured for use with other molded tube fittings and assemblies.

In some embodiments, the nesting station 300 and divert valves 350 can beneficially be used in conjunction with a disposable internal element, such as a manifold 200. Embodiments of the nesting station 300 and divert valves 350 can provide for multi-directional flow control, with a large number of flow path combinations. As described above, embodiments of the nesting station 300 and divert valves 350 can control liquid flow without contacting the process liquid. In some embodiments, the divert valves can be configured as single-flip switches to open and close (as opposed to, for example, a multi-turn valve design), and make use of a simple design to facilitate liquid/flow shut off and control. Alternatively, other divert valve designs can be used.

It is to be understood that the exemplary embodiments are merely illustrative of the invention and that many variations of the above-described embodiments can be devised by one skilled in the art without departing from the scope of the invention. It is therefore intended that all such variations be included within the scope of the following claims and their equivalents.

What is claimed is:

1. A system for sampling sterile liquids in a pharmaceutical environment, the system comprising:
a nesting station, the nesting station including one or more divert valves;
a manifold, disposed partially within the nesting station, the manifold comprising one or more tubes;
an input valve, coupled to the manifold, the valve being designed and dimensioned to control the flow of liquid into the manifold; and
one or more sampling pouches, each sampling pouch coupled to one of the tubes;
wherein each of the divert valves can be used to selectively control the flow of liquid from the manifold, into the sampling pouches.

2. The system of claim 1, wherein the manifold is formed as a single-piece molded assembly.

3. The system of claim 2, wherein the manifold is formed of silicone.

4. The system of claim 1, wherein one or more of the divert valves are cam valves.

5. The system of claim 1, wherein one or more of the divert valves controls the flow of liquid from the manifold by compressing one or more of the tubes.

6. The system of claim 1, wherein the input valve is formed of a material that can be sterilized via high-pressure steam.

7. A system for sampling liquids, the system comprising:
a nesting station, the nesting station including one or more divert valves;
a manifold, disposed partially within the nesting station, the manifold comprising one or more tubes and being formed as a single-piece molded silicone assembly;
an input valve, coupled to the manifold, the valve being designed and dimensioned to control the flow of liquid into the manifold; and
one or more sampling pouches, each sampling pouch coupled to one of the tubes;
wherein each of the divert valves can be used to selectively control the flow of liquid from the manifold, into the sampling pouches.

8. A system for sampling a liquid, the system comprising:
a nesting station, the nesting station including one or more divert valves;
a manifold, disposed partially within the nesting station, the manifold comprising one or more tubes and being formed as a single-piece molded silicone assembly;
wherein each of the divert valves can be used to selectively control the flow of liquid from the manifold.

9. The system of claim 8, comprising one or more sampling pouches, each sampling pouch coupled to one of the tubes.

10. The system of claim 8, wherein one or more of the divert valves controls the flow of liquid from the manifold by compressing one or more of the tubes.

11. The system of claim 8, comprising one or more sampling pouches, each sampling pouch coupled to one of the tubes.

12. A system for sampling a liquid, the system comprising:
a manifold comprising one or more tubes and being formed as a single-piece molded silicone assembly;
a means for stopping the flow of liquid in the tubes.

13. The system of claim 12, the system comprising a nesting station designed and dimensioned to support the manifold, the nesting station including one or more divert valves.

14. The system of claim 13, wherein one or more of the divert valves controls the flow of liquid from the manifold by compressing one or more of the tubes.

15. The system of claim 12, comprising one or more sampling pouches, each sampling pouch coupled to one of the tubes.

16. The system of claim 12, comprising an input valve, coupled to the manifold, the input valve being designed and dimensioned to control the flow of liquid into the manifold.

17. A system for sampling a liquid, the system comprising:
a sampling pouch, for collecting a sample of liquid; and
an input valve, coupled to the sampling pouch, the input valve being designed and dimensioned to control the flow of liquid into sampling pouch.

18. A method for sampling a liquid, the method comprising:
actuating an input valve to allow a liquid to flow into a manifold, the manifold comprising one or more tubes and being formed as a single-piece molded silicone assembly;
opening a divert valve on a nesting station, the nesting station at least partially supporting the manifold, the opened divert valve allowing the liquid to flow through one of the tubes and into a sampling pouch;
closing the divert valve; and
removing the sampling pouch.

19. The method of claim 18, the method comprising, applying high-pressure steam to the input valve, to sterilize at least a portion of the input valve.

20. A method of providing a sampling system, the method comprising:
providing a nesting station, the nesting station including one or more divert valves;
providing a manifold, disposed partially within the nesting station, the manifold comprising one or more tubes and being formed as a single-piece molded silicone assembly;
providing an input valve, coupled to the manifold, the valve being designed and dimensioned to control the flow of liquid into the manifold; and
providing one or more sampling pouches, each sampling pouch coupled to one of the tubes;
wherein each of the divert valves can be used to selectively control the flow of liquid from the manifold, into the sampling pouches.
